(19) United States
(12) Patent Application Publication
(10) Pub. No.: US 2014/0253386 A1
(43) Pub. Date: Sep. 11, 2014

(54) DEVICES, METHODS, AND APPARATUSES FOR COMPUTING ROUND-TRIP TIME OF A MESSAGE

(71) Applicant: QUALCOMM INCORPORATED, San Diego, CA (US)

(72) Inventors: Ming Sun, Santa Clara, CA (US); Weihua Gao, San Jose, CA (US); Yuhua Hu, Sunnyvale, CA (US); Gengsheng Zhang, Cupertino, CA (US); Sai Pradeep Venkatraman, Santa Clara, CA (US)

(73) Assignee: QUALCOMM Incorporated, San Diego, CA (US)

(21) Appl. No.: 13/794,559

(22) Filed: Mar. 11, 2013

(51) Int. Cl. G01S 5/10

(52) U.S. Cl. CPC G01S 5/10
USPC 342/387

(57) ABSTRACT

Methods, apparatuses, and/or articles of manufacture are disclosed, which may be employed in a mobile device communicating with a transponder via a near field communications channel. In one example, round trip time of a message may be computed to estimate processing latency contributed by processes occurring within the mobile device and/or the transponder.

### BACKGROUND

1. Field

The subject matter disclosed herein relates to mobile electronic devices, and more particularly to methods, apparatuses, and articles of manufacture which may be used in association with an estimate of location utilizing round-trip time of a message.

2. Information

Many mobile electronic devices, such as cellular telephones, portable satellite navigation devices, mobile computers, and the like, may include an ability to estimate location and/or position of the mobile device with a high degree of accuracy. An ability to estimate a mobile device's location may be made possible by any one of several signals-based position estimation technologies such as, for example, satellite positioning systems (e.g., the Global Positioning System (GPS) and the like), advanced forward-link trilateration (AFLT), observed time difference of arrival (OTDOA), enhanced cellular identification (ECID), just to name a few examples. These techniques may enable mobile device users to receive services such as, for example, emergency location services, vehicle or pedestrian navigation, location-based searching, and so forth.

Many location estimation techniques, such as those mentioned above, operate primarily in an outdoor environment in which a line-of-sight signal path exists between a mobile device and, for example, space vehicles of a satellite positioning system. Although indoor ranging and location estimation techniques exist, these techniques may be difficult to implement.

### SUMMARY

In an example implementation, a method may comprise, at a mobile device including a transceiver, placing a first antenna into proximity with a second antenna coupled to a transponder and transmitting, through the first antenna, coupled to the transceiver, a first message having a first time-stamp. The method may additionally include providing a second time-stamp in response to receipt of a second message transmitted by the transponder an response to the first message, wherein the second message comprises the first time-stamp. The method may conclude with estimating a processing latency based, at least in part, on comparing the first and second time-stamps.

In another example implementation, a mobile device may include a transceiver and one or more processors to detect presence of a near field communications channel at the transceiver. The one or more processors may additionally generate a first time-stamp for transmission using a far field communications channel and associate a time-stamp with a message received using the far field communications channel, wherein the received message includes the first time-stamp. The mobile device may also compare the first time-stamp with the time-stamp associated with the received message.

In another example implementation, an article comprises a storage medium comprising machine-readable instructions stored thereon which are executable by a special purpose computing apparatus to initiate transmission, in response to detection of a near field communications channel, a first message comprising a first time-stamp. Instructions may also be executable to associate a second time-stamp with a second message, the second message received through the far field communications channel and to compare the second time-stamp to the first time-stamp.

In another example implementation, a mobile device may comprise means for determining that a transceiver is proximate with a transponder via a near field communications channel and means for transmitting a first time-stamped message to the transponder. The mobile device may also include means for associating a second time-stamp with a second message, the second message transmitted by the transponder in response to the transponder receiving the first time-stamped message, the second message comprising the first time-stamp. The mobile device may further include means for determining processing latency of a transponder using the first and the second time-stamps.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic diagram of a network topology according to an embodiment.

FIG. 2 is a schematic diagram of a layout of an indoor environment in which an embodiment of a method for computing round-trip time of a message may be employed.

FIG. 3 is a diagram showing message delay contributors in a mobile device and a transponder according to an embodiment.

FIG. 4 is a schematic diagram showing certain features of a mobile device and transponder used for computing round-trip time of a message according to an embodiment.

FIG. 5 is a simplified flow diagram of a method for computing round-trip time of a message according to an embodiment.

FIG. 6 is schematic diagram showing certain features of a computing environment in a mobile device used for computing round-trip time of a message according to an environment.

### DETAILED DESCRIPTION

In the following detailed description, numerous specific details are set forth to provide a thorough understanding of claimed subject matter. However, those skilled in the art will understand that claimed subject matter may be practiced without these specific details. In other instances, methods, apparatuses, and/or systems that would be known by one of ordinary skill have not been described in detail so as not to obscure claimed subject matter. Some example methods, apparatuses, or articles of manufacture are disclosed herein that may be implemented, in whole or in part, to facilitate or support one or more operations or techniques for computing round-trip time of a message between a mobile device and a transponder. Computation of round-trip time of a message transmitted from a mobile device to a transponder and back to a mobile device may involve measuring one or more sources of processing latency introduced in a path between the transmitting mobile device and a transponder, for example. Latencies may arise from, for example, multipath propagation of the transmitted message modulated on a carrier signal as well as latencies introduced by signal and/or digital processing operations performed by the transmitter and/or the transponder. In implementations, computation of round-trip time, less estimated processing latency, may be utilized to compute an estimation of a range from a mobile device to a transponder. In certain implementations, an estimated range from a mobile device to a transponder may be associated with a radio “heat map” that may be used to refine an estimate of a location of a mobile device in an indoor environment, for example.

As used herein, “mobile device,” “mobile communication device,” “wireless device,” or the plural form of such terms may be used interchangeably and may refer to any kind of special purpose computing platform or apparatus that may from time to time occupy a position that changes. In some instances, a mobile communication device may, for example, be capable of communicating with other devices, mobile or otherwise, through wireless transmission or receipt of information according to one or more communication protocols. As a way of illustration, special purpose mobile communication devices, which may herein be referred to simply as “mobile devices,” may include, for example, cellular telephones, smart telephones, personal digital assistants, laptop computers, personal entertainment systems, tablet personal computers, personal audio or video devices, personal navigation devices, or the like. It should be appreciated, however, that these are merely examples of mobile devices that may be used, at least in part, to implement one or more operations or techniques for computing round-trip time of a message between a mobile device and a transponder, for example, and that claimed subject matter is not limited in this regard. It should also be noted that the terms “position” and “location” may be used interchangeably herein.

As used herein, the term “near field” may refer to voice, data, and/or other communications over short distances using an air interface and operating in accordance with ISO/IEC 18000-3 or other suitable standard. Communications may, for example, take place among mobile devices and transponders using a center frequency of 13.56 MHz, or may take place using a frequency band such as 125.0 to 134.0 KHz, for example. Mobile and/or stationary devices may be placed “proximate” with one another, which may comprise devices being at least momentarily in contact with one another, for example, or may be separated by distances ranging from a fraction of a centimeter up to, for example, 30.0 cm or more. In implementations, near field communications or at least detection of a near field communications channel may be employed to assist in measuring or estimating latencies in round-trip time computations introduced by multipath signal propagation and processing latencies introduced by transmitting mobile devices and/or transponders that provide a return message back to the transmitting device. Near field communication among mobile devices and transponders may be facilitated, at least in part, by way of an “inductive loop” antenna, for example, that generates a time-varying magnetic field. In implementations, a time-varying magnetic field may be modulated, for example, using amplitude shift keying, phase shift keying, or other suitable modulation technique, and claimed subject matter is not limited in this respect.

Also as used herein, the term “far field” may refer to voice and/or data communications over distances longer than those at which near field communications may take place. Far field communications may take place using Wi-Fi, Bluetooth, GPS, cellular telephone, or other signal type. A far field antenna may comprise a dipole, monopole, helix, patch, or other antenna configuration that radiates or receives a time-varying electromagnetic signal. A time-varying electromagnetic signal having field strength above a threshold level may be detected by receiving devices located up to 1.0 kilometer, 10.0 kilometers, or even hundreds or thousands of kilometers from the transmitting device. A time-varying electromagnetic field may be modulated, for example, using a wide variety of modulation techniques including amplitude shift keying, phase shift keying, quadrature phase shift keying, code division multiple access and/or other modulation techniques as described herein. In implementations, if latencies in round-trip message transport times can be calculated responsive to detection of a near field communications signal, which may involve the use of a near field communications antenna, a mobile device may switch to a far field communications signal path, which may include a far field communications antenna, to compute an estimated range from the mobile device to a transponder. Switching may occur at an “application layer” or may occur at a lower layer of a computing platform of mobile device, in accordance with an Open Systems Interconnection model. Thus, at least in some implementations, switching may occur at an application layer, a presentation layer, a session layer, a transport layer, a network layer, a data link layer (i.e., media access control layer), a physical layer, or any combination thereof.

As alluded to above, an initial or updated estimate of the location of a mobile device may be obtained after detecting presence of a near field communications channel by measuring or computing round-trip time of a message transmitted from a mobile device and received by transponder, wherein a response message may be returned to the mobile device by the transponder. Assistance in computing a round-trip time may be selectively provided to a mobile device, such as by way of an indoor navigation system, a wireless access point, or other device capable of performing a transponder function. Such assistance may permit a mobile device to compute an estimate of round-trip processing latency between a mobile device and transponder. In some implementations, assistance in computing round-trip time of a message may be provided by way of a first mobile device that implements, for example, a transponder function using a near field communications channel. In other implementations, a near field communications channel may be used only momentarily to detect that a mobile device is proximate with a transponder and a far field antenna may be used to implement, for example, a transponder function to compute round-trip processing latency.

As discussed below, in some instances, an estimated location of a mobile device may, for example, be computed in connection with one or more radio heat maps for an indoor or like environment. In some instances, a radio heat map showing an electronic digital map (e.g., floor plans, etc.) associated with an indoor or like area of interest (e.g., a shopping mall, retailer outlet, etc.) may be provided to a mobile device at or upon entering an area, just to illustrate one possible implementation. An electronic digital map may include, for example, indoor features of an area of interest, such as doors, hallways, staircases, elevators, walls, etc., as well as points of interest, such as restrooms, stores, entry ways, pay phones, or the like. An electronic digital map may, for example, be stored at a suitable server to be accessible by a mobile device, such as via a selection of a Uniform Resource Locator (URL), for example. By obtaining a digital map of an indoor or like area of interest, a mobile device may, for example, be capable of overlaying its current location on the displayed map of the area so as to provide a user with additional context, frame of reference, or the like.

At times, computing round-trip time of a message transmitted from a mobile device and returned by a transponder may be used in conjunction with, for example, one or more radio heat maps constructed to estimate a location of a mobile device. A radio heat map may, for example, be provided in the form of heat map values or like metadata representing observed characteristics of wireless signals or so-called signal “signatures” indicative of expected signal strength, round-trip latencies, or like characteristics at particular locations in an indoor or like area of interest. For purposes of explanation, typically, although not necessarily, a radio heat map may, for example, be defined, at least in part, by a grid of points laid over or mapped to a floor plan of an indoor or like area of interest at relatively uniform spacing (e.g., two-meter separation of neighboring grid points, etc.) and represent expected signal strength signatures at these points. As such, heat map values associated with one or more known access points may, for example, enable a mobile device to correlate or associate observed signal strength signatures with estimated ranges from one or more transponders within an indoor or like area of interest. In implementations, media access control identification (MAC ID) address may be utilized to identify particular access points, transponders, wireless transmitters, or other assisting devices.

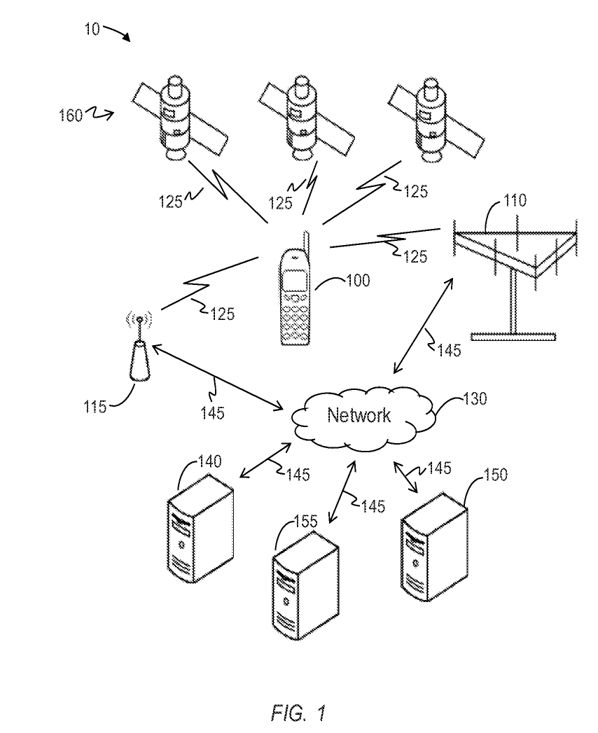

FIG. 1 is a schematic diagram of a network topology 10 according to an embodiment. As described below, one or more processes or operations for computing round-trip time of message may be implemented in a signal environment that may be utilized by a mobile device 100, for example. It should be appreciated that network topology 10 is described herein as a non-limiting example that may be implemented, in whole or in part, in the context of various communications networks or combination of networks, such as public networks (e.g., the Internet, the World Wide Web), private networks (e.g., intranets), wireless local area networks (WLAN, etc.), or the like. It should also be noted that claimed subject matter is not limited to indoor implementations. For example, at times, one or more operations or techniques described herein may be performed, at least in part, in an indoor-like environment, which may include partially or substantially enclosed areas, such as urban canyons, town squares, amphitheaters, parking garages, rooftop gardens, patios, or the like. At times, one or more operations or techniques described herein may be performed, at least in part, in an outdoor environment.

As illustrated, network topology 10 may comprise, for example, one or more space vehicles 160, base transceiver station 110, wireless transmitter 115, etc. capable of communicating with mobile device 100 via wireless communication links 125 in accordance with one or more protocols. Space vehicles 160 may be associated with one or more satellite positioning systems (SPS), such as, for example, the United States Global Positioning System (GPS), the Russian GLONASS system, the European Galileo system, as well as any system that may utilize space vehicles from a combination of SPSs, or any SPS developed in the future. Space vehicle 10 may also represent one or more orbiting space vehicles of a regional satellite navigation system such as, for example, Quasi-Zenith Satellite System (QZSS) over Japan, Indian Regional Navigational Satellite System (IRNSS) over India, Beidou/Compass over China, etc., and/or various augmentation systems (e.g., an Satellite Based Augmentation System (SBAS)) that may be associated with or otherwise enabled for use with one or more global and/or regional navigation satellite systems. It should be noted that claimed subject matter is not limited to the use of space vehicles such as those space vehicles of the aforementioned global or regional satellite navigation systems. Base transceiver station 110, wireless transmitter 115, etc. may be of the same or similar type, for example, or may represent different types of devices, such as access points, radio beacons, cellular base stations, femtocells, or the like, depending on an implementation. At times, one or more wireless transmitters, such as wireless transmitters 115, for example, may be capable of transmitting as well as receiving wireless signals.

In some instances, one or more base transceiver stations 110, wireless transmitters 115, etc. may, for example, be operatively coupled to a network 130 that may comprise one or more wired or wireless communications or computing networks capable of providing suitable information, such as a radio heat map, via one or more wireless communication links 125, 145, and so forth. As discussed below, information may include, for example, a radio heat map showing an electronic digital map (e.g., floor plans, etc.) associated with an indoor or like area of interest (e.g., a shopping mall, retailer outlet, etc.) that may be provided to a mobile device at or upon entering the area. In particular implementations, a radio heat map may comprise a look-up table, a mathematical formula, a suitable model, an algorithm, heat map metadata, and so forth.

In an implementation, mobile device 100 and wireless transmitter 115 may further include a capability for near field communications, or at least the detection of a near field communications signal, over distances of less than 30.0 cm, for example, in accordance with ISO/IEC 18000-3. Additionally, network 130 may be capable of facilitating or supporting communications among suitable computing platforms or devices, such as, for example, mobile device 100, one or more base transceiver stations 110, wireless transmitters 115, as well as one or more servers associated with network topology 10. In some instances, servers may include, for example, a location server 140, positioning assistance server 155, as well as one or more other servers, indicated generally at 150 (e.g., navigation, information, map, etc. server, etc.), capable of facilitating or supporting one or more operations or processes associated with network topology 10.

Even though a certain number of computing platforms or devices are illustrated herein, any number of suitable computing platforms or devices may be implemented to facilitate or otherwise support one or more techniques or processes associated with network topology 10. For example, at times, network 130 may be coupled to one or more wired or wireless communications networks (e.g., Wi-Fi, etc.) so as to enhance a predominantly indoor coverage area for communications with mobile device 100, one or more base transceiver stations 110, wireless transmitters 115, servers 140, 150, 155, or the like. In some instances, network 130 may facilitate or support femtocell-based operative regions of coverage, for example. Again, these are merely example implementations, and claimed subject matter is not limited in this regard.

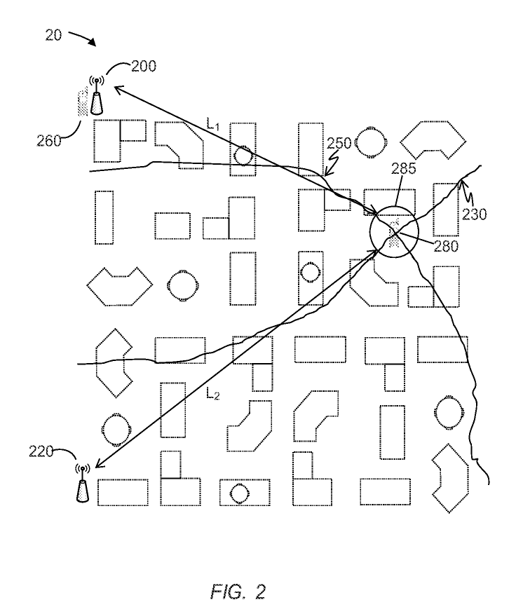

FIG. 2 is a schematic diagram of a layout 20 of an indoor environment in which a method for computing round-trip time of a message may be employed according to an embodiment. As explained in greater detail below, transponder 200 is shown as being in close proximity with mobile device 260 in an upper left portion of FIG. 2. In certain implementations, mobile device 260 and transponder 200 are capable of communicating at close ranges, such as by way of a near field communications channel using, for example, inductive loop antennas for transmitting and/or receiving a time-varying magnetic field. Transponder 200, etc. may represent an access point, a radio beacon, a cellular base station, a femtocell, or the like. In particular implementations, transponder 200 may correspond to a mobile device tethered to a laptop computer having an Internet connection to create a mobile “hotspot.”

In implementations, near field communication may take place when mobile device 260 and transponder 200 are proximate with another, such as over a distance of 0.0 cm (i.e., mobile device 260 and transponder 200 are in at least momentary intimate contact with one another) up to, for example, approximately 30.0 cm. Such communications using a near field channel may permit mobile device 260, assisted by transponder 200, to estimate processing latency introduced by operations performed within mobile device 260 and transponder 200. In certain implementations, processing latencies may comprise latencies introduced by downconversion, demodulating, parsing a demodulated message, inserting information states of a response message into one or more media access control frames, processing a request extracted from one or more media access control message frames, generating a response message modulating a response message, upconverting a response message, and other contributors.

In implementations, if processing latencies can be accounted for in a calculation of round-trip time between, for example, mobile device 280 and transponder 200, the corrected RTT may be used to estimate the range (L₁) of mobile device 280 from transponder 200. Confidence ellipse 285 may represent, at least in certain implementations, an outer boundary that defines an area within which mobile device 280 may be estimated to be located at a particular confidence level. For example, a relatively small confidence ellipse may indicate an area within which mobile device 280 may be expected to be located at a lower confidence level, such as 50%, for example. A relatively large confidence ellipse may define an area within which mobile device 280 may be estimated to be located at a higher confidence level, such as 90%, for example.

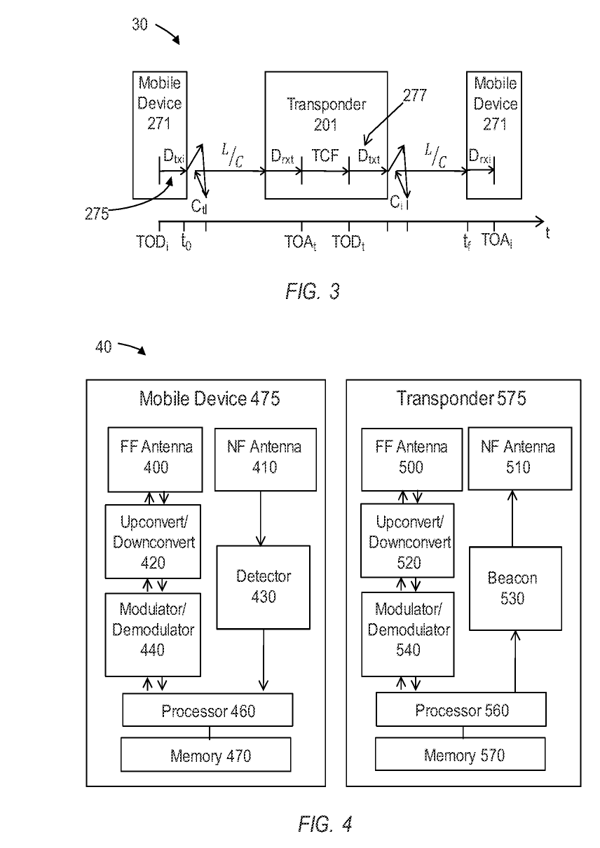

Turning briefly to FIG. 3, a schematic diagram 30 shows message delay contributors in a mobile device and a transponder according to an embodiment. FIG. 3 may be used to visualize contributors to round-trip time latencies, for example, between transponder 200 and mobile device 260 of FIG. 2. In FIG. 3, mobile device 271 may transmit a message by way of a modulated carrier signal, represented by arrow 275, to transponder 201. In response to receiving a message from mobile device 271, transponder 201 may return a second message modulated on a carrier signal, represented by arrow 277. It should be noted that mobile device 271 is shown in two places in FIG. 3 so that elements contributing to processing latency may be associated with the tune line beneath mobile device 271 and transponder 201.

At a time represented by TODᵢ, on the t axis of FIG. 3, a message may be generated at mobile device 271. In implementations, a message may be placed onto a carrier signal using any number of modulation techniques, such as direct-sequence spread spectrum, frequency-hopping spread spectrum, orthogonal frequency-division multiplexing, or the like, which may be used to convey an modulated signal from mobile device 271 to transponder 201. In at least one embodiment, mobile device 271 makes use of an 802.11 network standard such as IEEE 802.11a, 802.11b, 802.11g, 802.11n, or any other standard communications protocol which may be appropriate for indoor and/or outdoor wireless communications. A message may be formed by one or more processors of mobile device 271 responsive to one or more user inputs or may be initiated without user input as part of a network discovery process initiated, for example, if mobile device 271 detects a beacon or other signal emanating from transponder 201. In the embodiment of FIG. 3, mobile device 271 may insert a time-stamp, such as TODᵢ, into a message scheduled for transmission to transponder 201. A time-stamp (e.g., TODᵢ) may be inserted into a payload portion of an IEEE 802.11 compliant message frame, or may be inserted into any other appropriate location of a message frame generated by mobile device 271. It should be noted that a variety of wireless messaging standards may be applicable, and time information may be inserted at various locations according to any suitable wireless message protocol, and claimed subject matter is not limited in these respects.

In the embodiment of FIG. 3, mobile device 271 as well as transponder 201 may operate in accordance with, for example, the Open Systems Interconnection model. In such a device, messages may be generated and interpreted in accordance with a computer program or other sequence of computer instructions operating at an application layer. However, one or more of mobile device 271 and transponder 201 may perform according to different systems models, and claimed subject matter is not limited in this respect. Nonetheless, if a message is generated at an application layer, mobile device 271 may consume, for example, a time period approximately equal to Dₜₓᵢ as a message, is generated, time-stamped, and conveyed to a media access control (MAC) layer for modulation and upconversion to a carrier frequency. In FIG. 3, tₒ may represent a delay attributed to such interlayer transport time.

At a time represented by tₒ, an upconverted modulated signal at a carrier frequency may travel to transponder 201 by way of multiple signal paths. For example, in an indoor wireless communications environment, a signal may travel between two points by way of a direct, line-of-sight path as well as by way of reflecting from walls, ceilings, floors, and/or other obstructions. In FIG. 3, a delay arising from multiple path (or “multipath”) signal propagation may be represented as Cₜ. FIG. 3 also indicates nominal (e.g., line-of-sight) travel time between mobile device 271 and transponder 201 as L/C, wherein “L” represents a physical distance (e.g., in meters) between mobile device 271 and transponder 201, and “C” represents the speed of light (e.g., in meters/second) for the medium between device 271 and transponder 201. After traveling a distance “L” from mobile device 271, a modulated signal may be received at transponder 201.

In FIG. 3, a time delay Dᵣₓₜ introduced by signal processing and data processing carried out by transponder 201 may include downconversion, demodulation, interlayer transport from a MAC layer to an application layer. Dᵣₓₜ may also include processing time at an application layer to extract a time-stamp from an incoming time-stamped message. In implementations, time TOAₜ, is measured by transponder 201 and may indicate the start of a time delay identified as “TCF.” TCF may represent a processing delay at an application layer. TCF may further comprise a time involved in accessing computer program instructions and/or other information states stored in a memory to interpret or parse content of a demodulated message and to prepare a response message. In certain implementations, a response message may include, for example, a time-stamp extracted from an incoming message, such as a time-stamped message generated by mobile device 271 at time TODₜ. It should be noted, however, that transponder 201 may perform a variety of other operations during TCF including inserting a time generated by an internal clock into a response message, and claimed subject matter is not limited in this regard.

A response message may then be conveyed from an application layer of transponder 201 to a MAC layer at a time TODₜ, which may be measured by transponder 201. A response message may be modulated, upconverted, and transmitted to mobile device 271. In FIG. 3, latency introduced by such processes at transponder 201 may be represented by Dₜₓₜ. After the modulated signal exits transponder 201, the signal may undergo multipath delays, as represented by Cᵢ in FIG. 3. A nominal transport time of the return signal is again represented by L/C, wherein “L” indicates a physical distance between, for example, mobile device 271 and transponder 201, and “C” indicates the speed of light for the medium between transponder 201 and mobile device 271. At a time identified as t_{f}, a modulated signal may be received at mobile device 271. The received message may then be downconverted, demodulated, and transported from a MAC layer to an application layer, for example. An application layer may associate a time-stamp t_{f} to a message, at an application layer, and compare a received timestamp TOAₜ, with TODᵢ. In FIG. 3, Dᵣₓᵢ indicate latency introduced downconversion and other processes by mobile device 271.

Accordingly, round-trip time (RTT) between a mobile device and a transponder may be expressed as a summation of individual contributing time delays according to expression (1) as follows:

RTT=Dₜₓᵢ+Cₜ+L/C+Dᵣₓₜ+TCF+DₜₓₜCᵢ+L/C+Dᵣₓᵢ (1)

Thus, from FIG. 3, it may be expected that if an intervening distance between mobile device 271 and transponder 201 can be reduced to approximately 0.0, or other negligible amount, expression (1) simplifies to expression (2) as follows:

RTT_{near field}=Dₜₓᵢ+Dᵣₓₜ+TCF+Dₜₓₜ+Dᵣₓᵢ (2),

which corresponds to expression (1) with Cₜ, Cᵢ, and L/C≈0.0. In certain implementations, RTT_{near field} may approximate processing latency in round-trip time calculation between mobile device 271 and transponder 201. Expression (2) may be likened, for example, to the arrangement shown in an upper left portion of FIG. 2, in which mobile device 260 and transponder 200 are proximate with one another including being in contact with one another. In implementations, communications between mobile device 260 and transponder 200 may occur by way of a near field communications channel operating at short ranges (e.g. 0.0 cm to 30.0 cm). In implementations, the use of near field communications may represent a simplified process for determining processing latency within mobile devices and wireless transmitters, such as Dₜₓᵢ+Dᵣₓₜ+TCF+Dₜₓₜ+Dᵣₓᵢ, for example.

To further illustrate the processes discussed in FIG. 3, FIG. 4 is a diagram of an embodiment 40 showing certain features of a mobile device and transponder used for computing round-trip time of a message. As alluded to above, mobile device 475 includes a capability for communications by way of near field antenna 410, which may comprise an inductive loop capable of generating and/or receiving a time-varying magnetic field at approximately 13.56 MHz In addition, mobile device 475 includes far field antenna 400 that permits the mobile device to communicate over much longer distances terrestrial cellular base stations, wireless access points, space vehicles of an SPS, and so forth, as described in relation to FIG. 1.

In some implementations, transponder 575 may correspond to a wireless transmitter, such as transponder 200 of FIG. 2, a wireless access point, or other mobile device capable of performing transponder functions. In particular implementations, transponder 575 may correspond to a mobile device tethered to a laptop computer having an Internet connection to create a mobile “hotspot.” A connection of the mobile device to a laptop computer, for example, may comprise a wireless LAN connection, a Bluetooth connection, or a physical connection by way of a cable between the mobile device and the laptop. It should be noted that claimed subject matter is intended to embrace all such implementations in which a mobile communications device performs or assists in performing transponder functions for computing round-trip time of a message.

In implementations, if mobile device 475 is placed into proximity with transponder 575, such as within a distance of less than 30.0 cm, for example, a time-varying magnetic field of at least a threshold strength generated by a near field antenna of the transponder may excite electrical currents on conductors of near field antenna 410. In certain implementations, near field antennas 410 and 510 may correspond to inductive loops that respond, at least in part, to a presence of a time-varying magnetic field by inducing electrical currents on conductors of an inductive loop. Time-varying electrical currents larger than a threshold level from near field antenna 410 may be detected by detector module 430. Responsive to detection of a near field communications signal, which may, for example, be transmitted by beacon 530 of transponder 575, processor 460 may determine that a near field communications channel between mobile device 475 and transponder 575 exists.

Responsive to determining that a near field communications channel exists, computer program instructions stored within memory 470, processor 460 may initiate a method for estimating processing latency of mobile device 475 in communication with transponder 575. In particular implementations, processor 460 may initiate a method for estimating processing latency in response to input from a user of mobile device 475 or may initiate the process without user input. It should be noted however, that processor 460 may respond to various stimuli, such as in response to stored computer instructions, in response to a user input, or in response to a combination of the two to initiate the method.

At least partially in response to detecting presence of a communications channel, processor 460 may initiate a method for estimating processing latency by generating a message including a time-stamp corresponding to a current time, TODᵢ. The message may be conveyed to a media access control layer for modulation by modulator/demodulator module 440 and upconversion by upconvert/downconvert module 420. In implementations, signal for transmission using far field antenna 400 may utilize, for example, using amplitude shift keying, phase shift keying, Code Division Multiple Access, or any other suitable modulation technique such as those described herein, and claimed subject matter is not limited in this respect.

The modulated message comprising a time-stamp may be upconverted by upconvert/downconvert module 420 to a frequency of, for example, approximately 2.4 GHz, and coupled to far field antenna 400. Far field antenna 400 may generate a time-varying magnetic field for receipt by far field antenna 500 of transponder 575. A modulated signal received by far field antenna 500 may be downconverted by way of upconvert/downconvert module 520, demodulated by way of modulator/demodulator 540 and conveyed to processor 560. Processor 560, in response to program instructions stored in memory 570, for example, may parse a received message including, but not limited to, extracting a time-stamp from a received message and preparing a response message. In implementations, a response message formed by processor 560 may include extracted time, TODᵢ. A response message may include other encoded information, such as a time of day of as reported by a transponder internal clock, positioning estimates, MAC ID address, and so forth, and claimed subject matter is not limited in this respect. A response message comprising an extracted time-stamp (TODᵢ) may be formatted into a media access control message frame, modulated, upconverted, and transmitted using far field antenna 500.

Mobile device 475 may receive a transmitted signal from transponder 575 by way of far field antenna 400. A received signal may be downconverted using upconverted/downconvert module 420 and demodulated by way of modulator/demodulator 440. Processor 460 may then parse or otherwise interpret a received message including, but not limited to, extracting a time-stamp, TODᵢ. Processor 460 may then, in response to computer program instructions stored in memory 470, compare an extracted time-stamp (TODᵢ) with a current time-stamp (e.g., TOAᵢ). In implementations, a difference in extracted time-stamps may be approximately equal processing latencies for a message conveyed between mobile device 475 and transponder 575, which may be summarized in expression (3) as follows:

RTT_{near field}=TOAᵢ−TODᵢ=Dₜₓᵢ+Dᵣₓₜ+Dₜₓₜ+Dᵣₓᵢ+TODₜ−TOAₜ (3)

As mentioned above, expression (3) corresponds to expression (1) in which the effects of multipath signal propagation and delays introduced by nominal transport times to and from transponder 575 (e.g., L/C, Cₜ, and Cᵢ) are approximately equal to 0.0.

Returning briefly to FIG. 2, having estimated message round-trip time introduced by processing latencies, a mobile device may be relocated a larger distance from transponder 200, such as shown by mobile device 280. At such location, processing latencies introduced by Dₜₓᵢ, Dᵣₓₜ, TCF, Dₜₓₜ, and Dᵣₓᵢ may be subtracted from any message round-trip time computation between transponder 200 and mobile device 280. In implementations, if a mobile device has been relocated away from a transponder, such as transponder 200 of FIG. 2, a mobile device may generate one or more additional messages for transmission to a transponder. A transponder may receive a modulated signal from a mobile device and, at an application layer, may extract a time-stamp from a received message. A transponder may then form a response message and insert the extracted time-stamp into one or more response messages for transmission to a mobile device. A response message may be received by a mobile device wherein an extracted time-stamp may be compared with a current time to determine an uncorrected round-trip time from mobile device 280 to transponder 200. In implementations, a mobile device may subtract an estimated processing latency from an uncorrected RTT to obtain a corrected RTT from Mobile device 280 to transponder 200 to estimate a range between the mobile device and the transponder.

Returning now to FIG. 4, if time-varying electrical currents above a predetermined threshold are not detected by detector module 430, processor 460 may recognize an absence of a near field communications channel. In response, processor 460 may switch to communicating primarily or exclusively using far field antenna 400, which may enable mobile device 475 to communicate with far field antenna 500 of transponder 575 over much larger ranges, such as 25.0 meters, 1.0 km, 10.0 km, or larger range, for example.

Further, many implementations may involve the use of a separate signal path used to conduct near field communications. Thus, in implementations, selection of a near field signal path may include, for example, near field antenna 410, a near field upconvert/downconvert module, and/or a near field modulator/demodulator. Thus, selection of a near field versus a far field communications signal path may be regarded by processor 460 as a selection among two independent signal channels at a physical layer. Likewise, selection between a near field signal path and a far field signal path by transponder 575, which may involve far field antenna 500, upconvert/downconvert module 520, and modulator/demodulator 540, may be regarded by processor 560 and memory 570 as a selection among two independent signal channels at a physical layer. It should be noted, however, that in some implementations, a selection of a near field/far field communications channel may impose constraints on a use of processor 460 and/or processor 560. These may include, for example, disabling or enabling certain functions of processor 460, utilizing a second processor in lieu of processor 460, or otherwise modifying the performance of processor 460, and claimed subject matter is not limited in this regard.

Returning briefly to FIG. 2, mobile device 270 within confidence ellipse 285 can be seen as located a distance L₁ from transponder 200 and a distance L₂ from transponder 220. In implementations, distance L₁ may be calculated by solving expression (1) for the variable L₁. Accordingly, for determining L₁, expression (1) may simplifies as expression (4) as follows:

RTT=Dₜₓᵢ₁+Cₜ₁+L₁/C+Dᵣₓₜ₁+TODₜ₁−TOAₜ₁+Dₜₓₜ₁+Cᵢ₁+L₁/C+Dᵣₓᵢ₁ (4)

Expression (4) can be solved for L₁, under the assumption that multipath delay contributors (e.g., Cₜ₁ and Cᵢ₁) may be neglected and converting negative values of to L₁ to positive values, L₂ can be substituted for L₁ in expression (4) and the resulting expression can be solved for L₂ under the assumption that multipath delay contributors may be neglected and converting negative values of L₂ to positive values. A location of mobile device 280 may be estimated by positioning the mobile device within a confidence ellipse a distance L₁ from a first transponder and a distance L₂ from a second transponder, as shown in the layout of FIG. 2, for example.

In implementations, one or more radio heat maps may be used to improve accuracy of location estimations in response to message round-trip time computations. For example, FIG. 2 illustrates heat map boundaries 230 and 250, which can be seen superimposed on the layout of an indoor environment. Heat map boundary 230 may correspond, for example, to a boundary within which signal strength from transponder 200 is greater than a particular level, such as −70.0 dBm. Likewise, heat map boundary 250 may correspond to a boundary with in which signal strength from transponder 220 is above a particular level (e.g., −70.0 dBm). For reasons of clarity, additional heat map boundaries corresponding to other signal strength levels are not shown in FIG. 2. For example, a heat map boundary for a somewhat higher signal level, such as −60.0 dBm, may be expected to define a smaller area in between heat map boundary 230 and transponder 200. A heat map boundary for somewhat lower signal levels, such as −80.0 dBm, may be expected to intersect points at greater distances from transponder 200. At least in theory, any number of heat map boundaries can be overlaid on the layout of FIG. 2, and claimed subject matter is not limited in this respect.

As can be seen in FIG. 2, mobile device 280 is located at an approximate intersection of heat map boundaries 230 and 250. Thus, as alluded to above, a radio heat map may be provided to a mobile device in the form of heat map values or like metadata representing observed characteristics of wireless signals or so-called signal “signatures” indicative of expected signal strength, message round-trip times, or like characteristics at particular locations in an indoor or like area of interest. In particular implementations, a mobile device may compare a computed RTT estimate with one or more RTT values from a radio heat map. Following a comparison of estimated RTT values with RTT values from a radio heat map, a mobile device may determine a location estimate by performing a correlation between a computed RTT value and RTT signature values of a radio heat map for a particular MAC ID of a transponder. In addition to, or in place of round-trip times, a mobile device may associate ranges L1 and L2 with heat map signatures associated with transponder 200 and/or transponder 220. Accordingly, mobile device 280 may utilize heat map boundaries 250 and 230 to improve location estimation accuracy arising from computing estimates of L₁ and L₂. It should be noted that further improvements in location estimation accuracy may be gained by way of computing ranges from additional wireless transponders not shown in FIG. 2 as well as associating ranges with additional heat map signatures. Claimed subject matter is intended to embrace any number of location estimations as well as heat map signatures in obtaining estimates of locations of wireless devices.

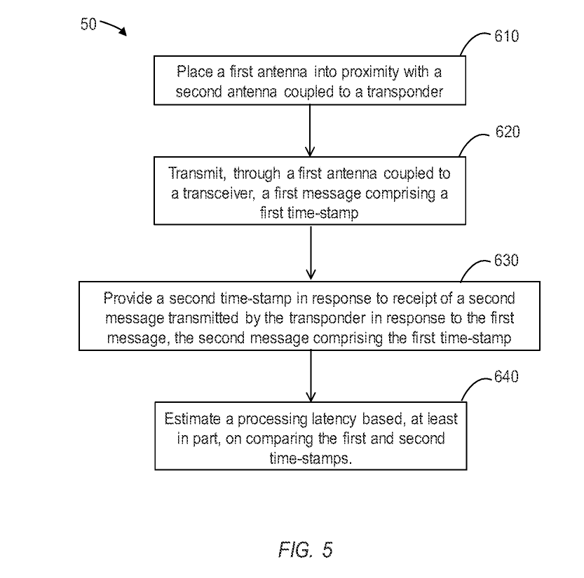

FIG. 5 is a simplified flow diagram of a method for computing round-trip time of a message according to an embodiment. The system of FIG. 4 may be suitable for performing the method of FIG. 4. However, claimed subject matter is not limited to the particular implementation of FIG. 4 and alternate arrangements of components in other implementations may be used. Example implementations, such as those described in FIG. 5 and others herein, may include blocks in addition to those shown and described, fewer blocks, blocks occurring in an order different than may be identified, or any combination thereof.

The method of HG. 5 begins at block 610 in which a first antenna is placed into proximity with a second antenna. In implementations, block 610 may include, for example, placing a first mobile device within a relatively small distance, such as less than 30.0 cm, for example, from of a second mobile device, thereby permitting the devices to communicate by way of a near field communications channel. In particular implementations, mobile devices may be equipped with inductive loop antennas that communicate by way of a modulated time-varying magnetic field communicating at approximately 13.56 MHz. However, claimed subject matter is not limited to particular antenna configurations, particular modulating techniques, or particular frequency ranges.

At block 620, the method continues with a transceiver transmitting, through a first antenna, a first message comprising a first time-stamp. In certain implementations a first message may be modulated to accord with an IEEE 802.11 essage comprising a current time of day according to an internal clock of a mobile device, for example. A first time-stamp may be generated at an application layer and transferred to a MAC layer for transmission by way of a far field communications antenna.

At block 630, if a transponder receives a message comprising a first time-stamp, a transponder may extract a first time-stamp from a received message and insert the first time-stamp into a second message. A second message may be modulated and transmitted to a transceiver by way of a far field communications channel. Responsive to receipt of a second message, a transceiver may provide a second time-stamp to a second message. The method may conclude at block 640, in which a transceiver may estimate the processing latency based, at least in part, on a second time-stamp associated with receipt of a second message.

In particular implementations, responsive to a mobile device being relocated, a third message comprising a third time-stamp may be generated by a mobile device. The third message may be modulated, upconverted, and transmitted to a transponder. If a transponder receives a signal comprising the modulated third message, the transponder may extract a time-stamp from the third message and transmit a fourth message, wherein the fourth message comprises the time-stamp from the third message. A time difference between the third and fourth time-stamps may be utilized by a mobile device to estimate a range between a transponder and a mobile device.

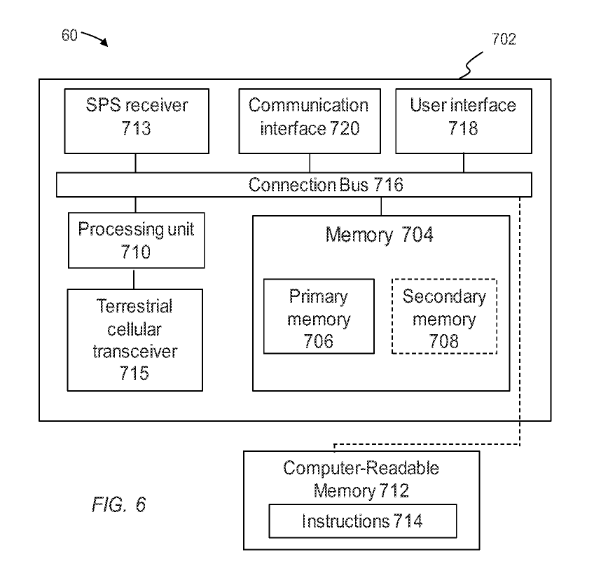

FIG. 6 is a schematic diagram 60 illustrating certain features of a computing environment for computing round-trip time of a message according to an example implementation. It may be appreciated that all or part of various devices or networks shown in computing environment 60, processes, or methods, as described herein, may be implemented using various hardware, firmware, or any combination thereof along with software.

A computing environment may include, for example, a mobile device 702, which may be communicatively coupled by way of near field communications channel and/or a far field communications channel (such as Wi-Fi, Bluetooth, or the like) to any number of other devices, mobile or otherwise, via a suitable communications network, such as a terrestrial cellular telephone network, the Internet, a mobile ad-hoc network, a wireless sensor network, a wireless access point, a Piconet, a femtocell, or the like. In an implementation, mobile device 702 may be representative of any electronic device, appliance, or machine that may be capable of exchanging information over a suitable communications network. For example, mobile device 702 may include one or more computing devices or platforms capable of benefiting from computing an estimate of round-trip time of a message between, for example, a wireless access point performing a transponder function and a mobile device. Round-trip time estimation may assist, for example, in estimating processing latencies of one or more of a mobile device and a transponder.

If round-trip time of the message can be estimated, a mobile device may estimate a range from a transponder if a mobile device has been relocated to a new location. To obtain an estimate of a mobile device's present location, the device may transmit a signal comprising a second time-stamp to a transponder. The transponder may insert the second timestamp into a response message transmitted back to the mobile device. The mobile device may process the response message from a transponder, and extracts the second timestamp from the response message. In response, the mobile device may compute an estimate of a round-trip time of message from the relocated transceiver and the transponder based, at least in part, on a difference between the second time-stamp and a time-stamp associated with a message from the transponder. A mobile device may utilize a heat map signature determining location associated with, for example, cellular telephones, satellite telephones, smart telephones, personal digital assistants (PDAs), laptop computers, personal navigation devices, or the like.

In certain example implementations, mobile device 702 may take the form of one or more integrated circuits, circuit boards, or the like that may be operatively enabled for use in another device. Although not shown, optionally or alternatively, there may be additional devices, mobile or otherwise, communicatively coupled to mobile device 702 to facilitate or otherwise support one or more processes associated with computing environment 60. Thus, unless stated otherwise, to simplify discussion, various functionalities, elements, components, etc. are described below with reference to mobile device 702 may also be applicable to other devices not shown so as to support one or more processes associated with example computing environment 60.

Memory 704 may represent any suitable or desired information storage medium. For example, memory 704 may include a primary memory 706 and a secondary memory 708. Primary memory 706 may include, for example, a random access memory, read only memory, etc. While illustrated in this example as being separate from a processing unit, it should be appreciated that all or part of primary memory 706 may be provided within or otherwise co-located/coupled with processing unit 710. Secondary memory 708 may include, for example, the same or similar type of memory as primary memory or one or more information storage devices or systems, such as, for example, a disk drive, an optical disc drive, a tape drive, a solid state memory drive, etc. In certain implementations, secondary memory 708 may be operatively receptive of, or otherwise enabled to be coupled to, a non-transitory computer-readable medium 712.

Computer-readable medium 712 may include, for example, any medium that can store or provide access to information, code or instructions, such as instructions 714 printed thereon (e.g., an article of manufacture, etc.) for one or more devices associated with computing environment 60. For example, computer-readable medium 712 may be provided or accessed by processing unit 710. As such, in certain example implementations, the methods or apparatuses may take the form, in whole or part, of a computer-readable medium that may include computer-implementable instructions stored thereon, which, if executed by at least one processing unit or other like circuitry, may enable processing unit 710 or the other like circuitry to perform all or portions of a location determination processes, with or without determining round-trip time of a message, within mobile device 702. In certain example implementations, processing unit 710 may be capable of performing or supporting other functions, such as communications, gaming, or the like.

Processing unit 710 may be implemented in hardware or a combination of hardware and software. Processing unit 710 may be representative of one or more circuits capable of performing at least a portion of information computing technique or process. By way of example but not limitation, processing unit 710 may include one or more processors, controllers, microprocessors, microcontrollers, application specific integrated circuits, digital signal processors, programmable logic devices, field programmable gate arrays, or the like, or any combination thereof.

Mobile device 702 may include various components or circuitry, such as, for example, SPS receiver 713, terrestrial cellular transceiver 715, and/or various other sensor(s), such as a magnetic compass, an inductive loop antenna to enable near field communications or least detection of near field communication channel, a gyroscope, etc. to facilitate or otherwise support one or more processes associated with computing environment 60. Although not shown, it should be noted that mobile device 702 may include an analog-to-digital converter (ADC) for digitizing analog signals from one or more sensors. Optionally or alternatively, such sensors may include a designated (e.g., an internal, etc.) ADC(s) to digitize respective output signals, although claimed subject matter is not so limited.

Although not shown, mobile device 702 may also include a memory or information buffer to collect suitable or desired information, such as, for example, received signal strength, as mentioned above. Mobile device 702 may also include a power source, for example, to provide power to some or all of the components or circuitry of mobile device 702. A power source may be a portable power source, such as a battery, for example, or may comprise a fixed power source, such as an outlet (e.g. in a house, electric charging station, etc.). It should be appreciated that a power source may be integrated into (e.g., built-in, etc.) or otherwise supported by (e.g., stand-alone, etc.) mobile device 702.

Mobile device 702 may include one or more connection bus 716 (e.g., buses, lines, conductors, optic fibers, etc.) to operatively couple various circuits together, and a user interface 718 (e.g., display, touch screen, keypad, buttons, knobs, microphone, speaker, trackball, data port, etc.) to receive user input, facilitate or support sensor-related signal measurements, or provide information to a user. Mobile device 702 may further include a communication interface 720 (e.g., wireless transceiver, modulator and/or demodulator, upconverter and/or downconverter, near field and/or far field antennas, etc.) to allow for communication between a mobile device and a transponder over one or more suitable communications networks.

In accordance with certain example implementations, communication interface 720 of FIG. 6, wireless transmitter 115 (FIG. 1), transponder 200 of FIG. 2, base transceiver station 110 (FIG. 1) may be enabled for operability with various wireless communication networks such as a wireless wide area network (WWAN), a wireless local area network (WLAN), a wireless personal area network (WPAN), and so on. The ter “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATS) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example. Wireless communication networks may include so-called next generation technologies (e.g., “4G”), such as, for example, Long Term Evolution (LTE), Advanced LTE, WiMAX, HRPD, Ultra Mobile Broadband (UMB), and/or the like. Additionally, communication interface 720 may further provide for infrared-based communications with one or more other devices.

The methodologies described herein may be implemented by various means depending upon applications according to particular features and/or examples. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs) processors, controllers, microcontrollers, microprocessors, electronic devices, other devices units designed to perform the functions described herein, and/or combinations thereof.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired outcome. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying”, “applying,” “generating,” and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A method, comprising, at a mobile device comprising a transceiver:
placing a first antenna into proximity with a second antenna coupled to a transponder;
transmitting, through said first antenna, coupled to said transceiver, a first message comprising a first time-stamp;
providing a second time-stamp in response to receipt of a second message transmitted by said transponder in response to said first message, said second message comprising said first time-stamp; and
estimating a processing latency based, at least in part, on comparing said first and second time-stamps.

2. The method of claim 1, wherein said estimating further comprises subtracting, by said transceiver, said first time-stamp from said second time-stamp.

3. The method of claim 1, and further comprising:
relocating said transceiver relative to said transponder;
transmitting a third message comprising a third time-stamp from said relocated transceiver to said transponder; and
said transponder transmitting a fourth message, said fourth message comprising said third time-stamp, said transmitting being at least partially in response to receipt of said third message; and
estimating a round-trip time (RTT) of a message between said relocated transceiver and said transponder based, at least in part, on a difference between said third time-stamp and a fourth time-stamp associated with receipt of said fourth message, less said estimated processing latency.

4. The method of claim 3, and further comprising:
computing an estimated range from said relocated transceiver to said transponder based, at least in part, on said estimated RTT.

5. The method of claim 3, and further comprising detecting, responsive to said relocation of said transceiver, that a near field communications channel is not present.

6. The method of claim 3, and further comprising:
estimating a location of said relocated transceiver based, at least in part, on an association of said estimated RTT with an RTT signature value from a radio heat map.

7. The method of claim 6, wherein said estimating said location of said relocated transceiver comprises:
comparing said estimated RTT with a plurality of RTT signature values of said radio heat map; and
determining said location estimate based, at least in part, on a correlation between said estimated RTT and at least one of said plurality of RTT signature values of said radio heat map.

8. The method of claim 1, and further comprising:
initiating said transmitting by said transceiver coupled to said first antenna at least partially in response to detection of a near field communications channel from said transponder.

9. The method of claim 8, wherein said detection of said near field communications channel comprises detection of a time-varying magnetic field having a strength above a threshold value.

10. The method of claim 1, herein said proximity between said first antenna and said second antenna comprises a distance of less than approximately 30.0 cm.

11. A mobile device comprising:
a transceiver; and
one or more processors to:
detect presence of a near field communications channel at said transceiver;
generate a first time-stamp for transmission using a field communications channel;
associate a time-stamp with a message received using said far field communications channel, said received message comprising said first time-stamp; and
compare said first time-stamp with said time-stamp associated with said received message.

12. The mobile device of claim 11, wherein said one or more processors additionally estimates a processing latency of a transponder communicating through said far field communications channel based, at least in part, on said comparing.

13. The mobile device of claim 12, wherein said one or more processors additionally:
initiate transmission, based at least in part on relocation of said transceiver, a message comprising a second time-stamp from said transceiver to said transponder; and
process a message from said transponder, said transponder transmitting a message comprising said second time-stamp; and
compute an estimate of round-trip time (RTT) of a message from said relocated transceiver and said transponder based, at least in part, on a difference between said second time-stamp and a time-stamp associated with said processed message from said transponder.

14. The mobile device of claim 13, wherein said one or more processors additionally detects an absence of a near field communications signal responsive to said relocation of said transceiver.

15. The mobile device of claim 13, wherein said one or more processors additionally computes an estimated range from said relocated transceiver to said transponder based, at least in part, on said computed estimate of RTT.

16. The mobile device of claim 15, wherein said one or more processors additionally estimate a location of said relocated transceiver based, at least in part, on an association of said estimated RTT with an RTT signature value from a radio heat map.

17. The mobile device of claim 16, wherein said one or more processors additionally associate said RTT signature value from said radio heat map based, at least in part, on a media access control identification (MAC ID) address received from said transponder.

18. The mobile device of claim 11, further comprising at least one inductive loop to receive and transmit near field communication signals.

19. The mobile device of claim 11, wherein said transceiver comprises a wireless access point.

20. The mobile device of claim 13, wherein said transceiver comprises a mobile communications device.

21. An article comprising:
a storage medium comprising machine-readable instructions stored thereon which are executable by a special purpose computing apparatus to:
initiate transmission, in response to detection of a near field communications channel, a first message comprising a first time-stamp;
associate a second time-stamp with a second message, said second message received through a far field communications channel; and
compare said second time-stamp to said first time-stamp.

22. The article of claim 21, wherein said storage medium additionally comprises machine-readable instructions stored thereon which are executable by a special-purpose computing apparatus to:
extract said first time-stamp from said message received through said far field communications channel.

23. The article of claim 21, wherein said storage medium additionally comprises machine-readable instructions stored thereon which are executable by a special-purpose computing apparatus to:
estimate a processing latency of a transponder communicating through said far field communications channel based, at least in part, on said comparing.

24. The article of claim 23, wherein said estimate of said processing latency of said transponder comprises at least one of the group consisting of:
latency for downconverting a modulated signal,
latency for demodulating said modulated signal,
latency for processing a request extracted from one or more media access control frames,
latency for forming a response using one or more media access control frames,
latency for modulating a signal comprising said response,
latency for upconverting said signal comprising said response,
or any combination thereof.

25. The article of claim 23, wherein said storage medium additionally comprises machine-readable instructions stored thereon which are executable by a special-purpose computing apparatus to:
initiate transmission, from a transceiver, of a third message comprising a third time-stamp if said transceiver has been relocated;
extract, from a message received from a transponder, said third time-stamp;
associate a fourth time-stamp with said message received from said transponder; and
compute an estimate of a round-trip time (RTT) of a message between said relocated transceiver and said transponder based, at least in part, on a difference between said third time-stamp and said fourth time-stamp, less said estimate of said processing latency.

26. The article of claim 25, wherein said storage medium additionally comprises machine-readable instructions stored thereon which are executable by a special-purpose computing apparatus to:
initiate transmission of said third message through said far field communications channel if said transceiver has been relocated.

27. The article of claim 25, wherein said storage medium additionally comprises machine-readable instructions stored thereon which are executable by a special-purpose computing apparatus to:
estimate a location of said relocated transceiver based, at least in part, on an association of said computed estimate of RTT with an RTT signature value from a radio heat map.

28. The article of claim 27, wherein said storage medium additionally comprises machine-readable instructions stored thereon which are executable by a special-purpose computing apparatus to:
associate said RTT signature value from said radio heat map based, at least in part, on a MAC ID address received from said transponder.

29. A mobile device comprising:
means for determining that a transceiver is proximate with a transponder via a near field communications channel;
means for transmitting a first time-stamped message to said transponder;
means for associating a second time-stamp with a second message, said second message transmitted by said transponder in response to said transponder receiving said first time-stamped message, said second message comprising said first time-stamp; and
means for determining processing latency of a transponder using said first and said second time-stamps.

30. The mobile device of claim 29, wherein said means for determining that a transceiver is proximate with a transponder comprises means for detecting presence of a time-varying magnetic field of a strength above a threshold level.

31. The mobile device of claim 29, wherein said means for transmitting comprises a far field antenna.

32. The mobile device of claim 29, wherein said means for determining that a transceiver is proximate with a transponder comprises an inductive loop.

33. The mobile device of claim 29, wherein said means for determining said processing latency comprises one or more processors to compare, at said mobile device, said first and said second time-stamps.

34. The mobile device of claim 29, further comprising means for determining round-trip time from said transceiver to said transponder responsive to relocating said transceiver.

35. The mobile device of claim 34, wherein said means for determining round-trip time from said transceiver to said transponder further comprises:
means for transmitting a third time-stamped message to said transponder via a far field antenna;
means for receiving a fourth message, said fourth message comprising said third time-stamp; and
means for determining a round-trip time of said third time-stamped message to said transponder, less said processing latency.

36. The mobile device of claim 35, further comprising means for detecting that a near field communications channel is absent.

37. The mobile device of claim 35 further comprising:
means for estimating a range from said mobile device to said transponder.

38. The mobile device of claim 37, wherein said means for estimating said range comprises means for associating an estimated RTT with an RTT signature value from a radio heat map.

39. The mobile device of claim 38, wherein said means for associating said estimated RTT with an RTT signature value comprises determining a MAC ID address received from said transponder.
